(19) United States
(12) Patent Application Publication
(10) Pub. No.: US 2019/0130380 A1
(43) Pub. Date: May 2, 2019

(54) MULTIMEDIA TERMINAL, INFORMATION PROCESSING SYSTEM, CONTROL PROGRAM, AND CONTROL METHOD

(71) Applicant: SHARP KABUSHIKI KAISHA, Sakai City (JP)

(72) Inventors: TAKASHI SAWANO, Sakai City (JP); MAYUKO YOSHIDA, Sakai City (JP); KUMIKO OGINO, Sakai City (JP); YASUHIRO NAKAI, Sakai City (JP); MASAO SAEDA, Sakai City (JP)

(21) Appl. No.: 16/177,436

(22) Filed: Nov. 1, 2018

(30) Foreign Application Priority Data
Nov. 1, 2017 (JP) 2017-211497

(51) Int. Cl. G06Q 20/22; G06Q 20/18

(52) U.S. Cl. CPC G06Q 20/29; G06Q 20/18

(57) ABSTRACT

An information processing device includes a CPU, a near field communication unit, and a money processing unit. The CPU communicates with an electronic money medium and acquires the amount of payable money using electronic money by controlling the near field communication unit. In addition, the CPU acquires the amount of payable money using the cash by controlling the money processing unit. Furthermore, the total amount of payable money, which is acquired by adding amount of payable money using the electronic money to the amount of payable money using the cash, is calculated. In a case where the total amount of payable money reaches the amount of money of the charge for the service or the like, settlement is permitted.

### BACKGROUND

### 1. Field

The present disclosure relates to a multimedia terminal, an information processing system, a control program, and a control method, and, in particular, to multimedia terminal, an information processing system, a control program, and a control method, which are capable of performing settlement of a charge using, for example, a plurality of payment methods.

### 2. Description of the Related Art

Japanese Unexamined Patent Application Publication No. 2009-20751 discloses an example according to the related art. A vending machine according to the related art includes a brand selection section that is used to select an electronic money settlement service of a plurality of brands, and an electronic money settlement control unit that performs settlement using the electronic money settlement service of a brand selected by the brand selection section. After a product is selected, an electronic money medium is put, the settlement is completed by the electronic money settlement control unit, and thus the product, which is accommodated in the vending machine, is sold.

However, in the vending machine according to the related art, there is a case where it is not possible to perform settlement in a case where a balance of electronic money is insufficient for a price of the product. In this case, it is demanded for the user to change a settlement method to cash or another electronic money or to perform settlement again after increasing the balance of the electronic money, thereby being troublesome. Therefore, there is room to improve convenience.

It is desirable to provide a new multimedia terminal, an information processing system, a control program, and a control method.

It is further desirable to provide a multimedia terminal, an information processing system, a control program, and a control method, which are capable of providing a flexible payment method and improving convenience of a user.

### SUMMARY

According to an aspect of the disclosure, there is provided a multimedia terminal, which is capable of performing settlement of a charge using a plurality of payment methods, and the multimedia terminal includes a detection section, a calculation section, a determination section, and a settlement permission section. The detection section detects a plurality of amounts of payable money corresponding to each of the plurality of payment methods; a calculation section that calculates a total amount of the plurality of amounts of payable money which is detected by the detection section. The determination section determines whether or not the total amount, which is calculated by the calculation section, reaches an amount of money of the charge. The settlement permission section that permits the settlement in a case where it is determined that the total amount reaches the amount of money of the charge by the determination section.

According to another aspect of the disclosure, there is provided an information processing system including the multimedia terminal, and an image forming device that is capable of communicating with the multimedia terminal.

According to still another aspect of the disclosure, there is provided a computer readable medium storing a control program of a multimedia terminal, which is capable of performing settlement of a charge using a plurality of payment methods, causing a processor of the multimedia terminal to function as a section, the section including: a detection section that detects a plurality of amounts of payable money corresponding to each of the plurality of payment methods; a calculation section that calculates a total amount of the plurality of amounts of payable money which is detected by the detection section; a determination section that determines whether or not the total amount, which is calculated by the calculation section, reaches an amount of money of the charge; and a settlement permission section that permits the settlement in a case where it is determined that the total amount reaches the amount of money of the charge by the determination section.

According to still another aspect of the disclosure, there is provided a control method causing a processor of a multimedia terminal, which is capable of performing settlement of a charge using a plurality of payment methods, to perform a process, the process including: (a) detecting a plurality of amounts of payable money corresponding to each of the plurality of payment methods; (b) calculating a total amount of the detected plurality of amounts of payable money; (c) determining whether or not the calculated total amount reaches an amount of money of the charge; and (d) permitting the settlement in a case where it is determined that the total amount reaches the amount of money of the charge.

### BRIEF DESCRIPTION OF THE DRAWINGS

FIG. 1 is a perspective diagram illustrating an exterior configuration of an information processing system which is an example of the disclosure;

FIG. 2 is a block diagram illustrating an electrical configuration of an information processing device illustrated in FIG. 1;

FIG. 3 is a block diagram illustrating an electrical configuration of an image forming device illustrated in FIG. 1;

FIG. 4 is a diagram illustrating an example of a payment method selection screen;

FIG. 5 is a diagram illustrating an example of the payment method selection screen in a state in which one payment method is selected;

FIG. 6 is a diagram illustrating an example of an electronic money reception screen;

FIG. 7 is a diagram illustrating an example of the payment method selection screen in a state in which a plurality of payment methods are selected;

FIG. 8 is a diagram illustrating an example of a memory map of a RAM of the information processing device illustrated in FIG. 2;

FIG. 9 is a diagram illustrating an example of a memory map of a RAM of the image forming device illustrated in FIG. 3;

FIG. 10 is a flowchart illustrating an example of a settlement process which is performed in a CPU illustrated in FIG. 2;

FIG. 11 is a diagram illustrating an example of a payment method selection screen according to a second embodiment; and

FIG. 12 is a diagram illustrating an example of a payment method selection screen according to a third embodiment.

### DESCRIPTION OF THE EMBODIMENTS

### First Embodiment

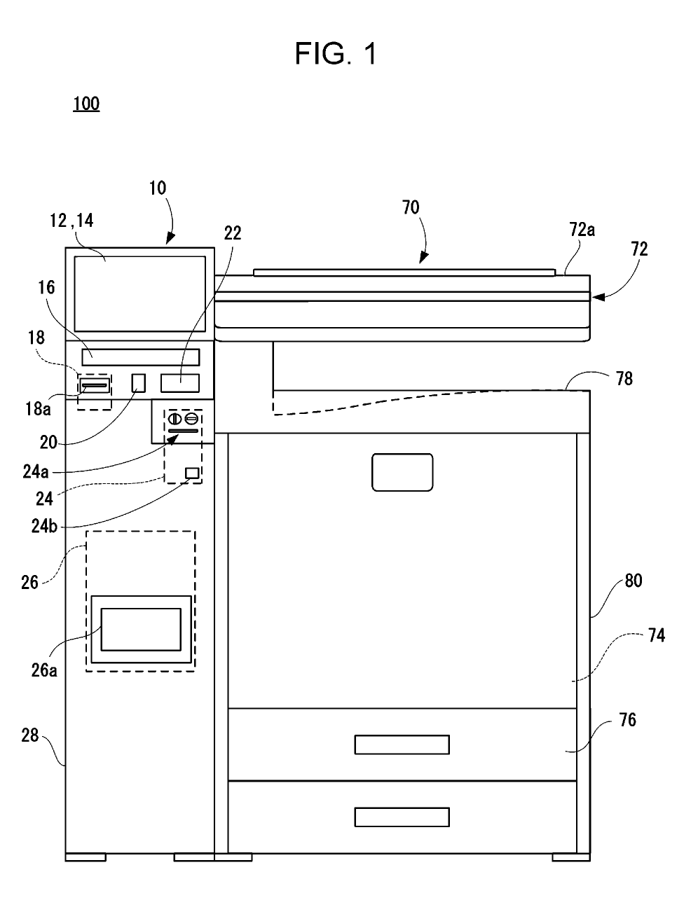

FIG. 1 is a diagram illustrating a configuration of an information processing system 100 according to the disclosure. Referring to FIG. 1, the information processing system 100 according to a first embodiment of the disclosure includes an information processing device 10 and an image forming device 70.

The information processing device 10 is a Multimedia Kiosk (MMK) terminal which is installed in a store, such as a supermarket, a restaurant, or a convenience store, or a public facility such as a station, a bus terminal, an airport, a government office, or a library. The information processing device 10 provides various pieces of information or a predetermined product or service (hereinafter, there is a case of being referred to as “service or the like”) to a user according to a location where the information processing device 10 is disposed. In addition, although details will be described later, the information processing device 10 is capable of providing the predetermined service, such as copying, printing, scanning, or faxing, to the user in cooperation with the image forming device 70.

Meanwhile, in the specification, a front and back direction (a depth direction) of the information processing device 10 and configuration members thereof is prescribed while setting a surface which faces a location where the user stands, that is, a surface on a side where a display 14 which will be described later is provided to a forward surface (front surface), and a right and left direction (a lateral direction) of the information processing device 10 and the configuration members thereof is prescribed on the basis of a state in which the information processing device 10 is viewed from the user. The directions are the same as in the image forming device 70.

The information processing device 10 includes a device main body 28 which includes a display 14 equipped with a touch panel 12, a recording medium connection unit 16, a paper piece printer 18, a symbol reading unit 20, a near field communication unit 22, a money processing unit 24, and a photo printer 26.

The display 14 equipped with the touch panel 12 is disposed at an upper end part of the information processing device 10 (device main body 28). The touch panel 12 is a general-purpose touch panel, and it is possible to use a random type, such as an electrostatic capacity type, an electromagnetic induction type, resistive film type, or an infrared ray type, of the touch panel. In the first embodiment, an electrostatic capacity type touch panel is used as the touch panel 12, and the touch panel 12 is provided on a display surface of the display 14. However, a touch panel display, in which the touch panel 12 and the display 14 are integrally formed, may be used. In addition, for example, it is possible to use an LCD, an Electro-Luminescence (EL) display or the like as the display 14.

The recording medium connection unit 16 includes a mounting unit (for example, a drive and a memory slot) used to mount various recording media. The various recording media includes an optical disk (for example, a CD-R, a DVD-R, or a BD-R), a flash memory (for example, a USB memory, an SD memory card, or a memory stick), and the like. However, the optical disk is mounted on the drive. In addition, the flash memory is mounted on the memory slot.

The paper piece printer 18 includes, for example, a thermal printer (thermosensitive printer) or a dot impact printer, and issues a paper piece, such as a receipt, a journal, or a coupon, on which an image is printed. Specifically, the paper piece printer 18 prints various strings, images, code patterns (a barcode and the like), or the like on a roll paper, and discharges a completely printed paper piece from a paper ejection unit 18a.

The symbol reading unit 20 includes, for example, a laser scanner, a camera, or the like, and is capable of reading a symbol which is attached to a product, a card, a receipt, or the like, a symbol which is di splayed on a screen of the user terminal (mobile terminal), or the like. The symbol, which is allowed to be read by the symbol reading unit 20, includes a barcode (one-dimensional barcode) or a 2-dimensional code (for example, a QR code (registered trade mark), a micro QR code, a Data MATRIX, a MaxiCODE, a VeriCODE, or the like).

The near field communication unit 22 wirelessly performs contactless data communication with a communication target in conformity to, for example, a communication standard (so-called Near Field Communication (NFC)) such as ISO/IEC18092. For example, the near field communication unit 22 wirelessly performs the contactless data communication with the communication target, such as an electronic money medium, in conformity to, for example, a communication standard such as Felica (registered trade mark). The electronic money medium is an IC card or a mobile terminal (a feature phone, a smart phone, a tablet PC, or the like). In addition, the electronic money medium includes a storage unit which stores data (electronic money data) relevant to a settlement process using electronic money. A communicable distance of the near field communication unit 22 is approximately a few cm to a few m. For example, the near field communication unit 22 transmits a signal (read command), which is used to instruct to read electronic money data stored in the electronic money medium, with respect to the electronic money medium. The electronic money medium transmits the electronic money data to the near field communication unit 22 in response to the read command. In addition, the near field communication unit 22 transmits data (write data) to be written in the electronic money medium and a signal (write command) which is used to instruct to write the data. The electronic money medium writes (stores) the received write data in the storage unit according to the write command. Meanwhile, the near field communication unit 22 is capable of communicating data other than the electronic money data with a communication target (for example, an identification card, a membership card, an employee card, or the like) other than the electronic money medium.

The money processing unit 24 includes a money insertion part 24a and a coin return opening 24b. The money insertion part 24a includes a coin insertion opening, a paper money insertion opening, a change return lever, and the like, and is disposed below the near field communication unit 22. A coin inserted from the coin insertion opening and paper money inserted from the paper money insertion opening are respectively classified for respective types and are accommodated in predetermined money storage sections (not illustrated in the drawing). The money storage sections include a coin storage section and a paper money storage section. In a case where the coin or the paper money is inserted, the amount of money to be inserted is calculated according to the type and the number of coins accommodated in the coin storage section and the type and the number of paper money accommodated in the paper money storage section. In a case where the predetermined service or the like is performed in the information processing device 10, costs (the charge relevant to provision of the service or the like) according to content of the service are subtracted from the amount of money to be inserted, and the amount of money (balance), which remains after subtracting the charge from the amount of money to be inserted, is calculated. In addition, in a case where the change return lever is operated, a coin or paper money is returned according to the balance. Meanwhile, the coin is returned from the coin return opening 24b provided below the money insertion part 24a, and the paper money is returned from the paper money insertion opening.

The photo printer 26 is, for example, a sublimation type printer or an ink jet printer, and prints an image on a photo paper. A photograph, which is printed by the photo printer 26, is discharged to a discharge unit 26a. Meanwhile, image data stored in the recording medium connected to the recording medium connection unit 16, image data transmitted from an external computer, or the like is used as image data used to form the image on the paper. In addition, a size of the photograph to be printed by the photo printer 26 includes an L size, a postcard size, a 2L size, or the like.

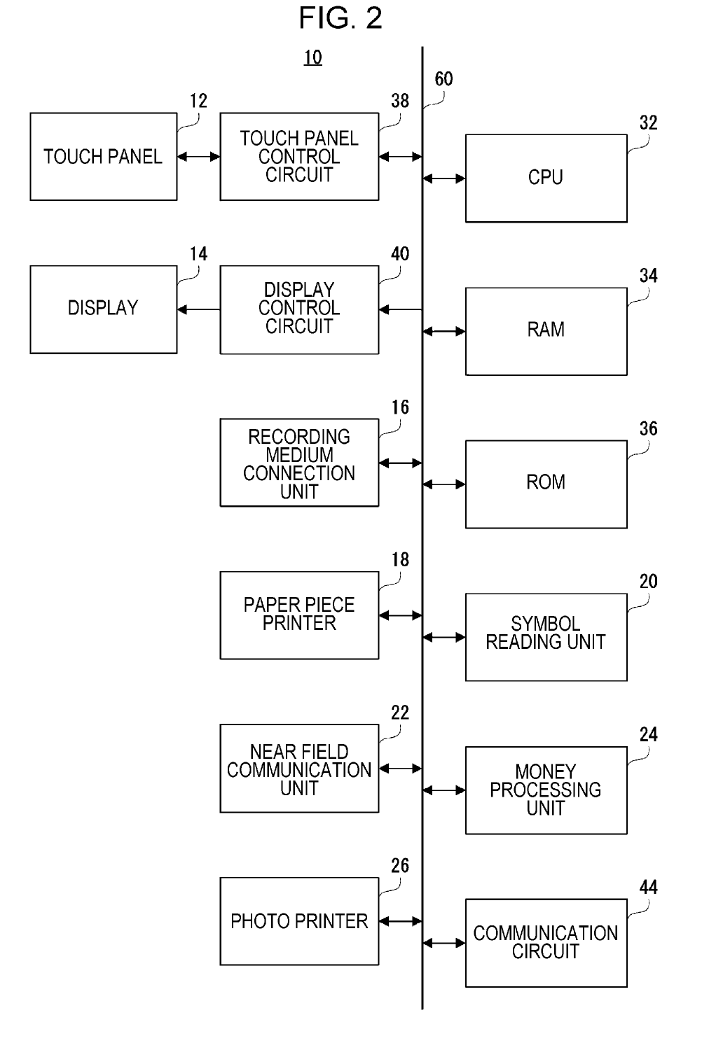

FIG. 2 is a block diagram illustrating an electrical configuration of the information processing device 10 illustrated in FIG. 1. Referring to FIG. 2, the information processing device 10 includes a CPU 32. A RAM 34, a RCM 36, a touch panel control circuit 38, a display control circuit 40, a recording medium connection unit 16, a paper piece printer 18, a symbol reading unit 20, a near field communication unit 22, a money processing unit 24, a photo printer 26, and a communication circuit 44 are connected to the CPU 32 through a bus 60. In addition, the touch panel 12 is connected to the touch panel control circuit 38, and the display 14 is connected to the display control circuit 40.

The CPU 32 performs overall control on the information processing device 10. The RAM 34 is used as a work area and a buffer area of the CPU 32. The ROM 36 stores a startup program of the information processing device 10 and default values for various pieces of information.

The touch panel control circuit 38 applies a desired voltage or the like to the touch panel 12, detects a touch operation (touch input) within an available touch range of the touch panel 12, and outputs touch coordinate data, which indicates a touch input location, to the CPU 32.

The display control circuit 40 includes a GPU, a VRAM, or the like. The GPU generates display image data, which is used to display various screens on the display 14, in the VRAM using image generation data stored in the RAM 34 under an instruction of the CPU 32, and outputs the generated display image data to the display 14.

The communication circuit 44 is a communication circuit used to connect a network such as the Internet. The communication circuit 44 is a wired communication circuit or a wireless communication circuit, and communicates with an external computer (external terminal), such as a server, according to the instruction from the CPU 32 via the network. Meanwhile, the communication circuit 44 is capable of directly communicating with the image forming device 70, a mobile terminal, or the like in a wired or wireless manner (for example, using an infrared ray method, a WiFi (registered trade mark) method, or a Bluetooth (registered trade mark) method) without passing via the network.

Meanwhile, the electrical configuration of the information processing device 10 illustrated in FIG. 2 is only an example, and the disclosure is not limited thereto.

Returning to FIG. 1, the image forming device 70 is a Multifunction Peripheral (MFP) which includes a copy function, a printer function, a scanner function, a facsimile function, and the like.

The image forming device 70 includes a device main body 80 which includes an image reading unit 72, an image forming unit 74, a paper feeding unit 76, and a paper discharge tray 78. Meanwhile, the image forming device 70 is installed in a vicinity of the information processing device 10. For example, the image forming device 70 is provided to be adjacent to a right side of the information processing device 10.

The image reading unit 72 includes a document pedestal which is formed of a transparent material, and is built in the device main body 80. A document pressing cover 72a is attached at an upper part of the document pedestal to be openable through a hinge or the like.

In addition, the image reading unit 72 includes a light source, a plurality of mirrors, an image formation lens, a line sensor, and the like. The image reading unit 72 exposes a document surface using the light source, and guides reflective light reflected from the document surface to the image formation lens through the plurality of mirrors. Furthermore, the image formation lens causes the reflective light to form the image on a light reception element of the line sensor. In the line sensor, brightness or chromaticity of the reflective light which forms the image on the light reception element is detected, and image data to be read is generated based on the image of the document surface. A Charge Coupled Device (CCD), a Contact Image Sensor (CIS), or the like is used as the line sensor.

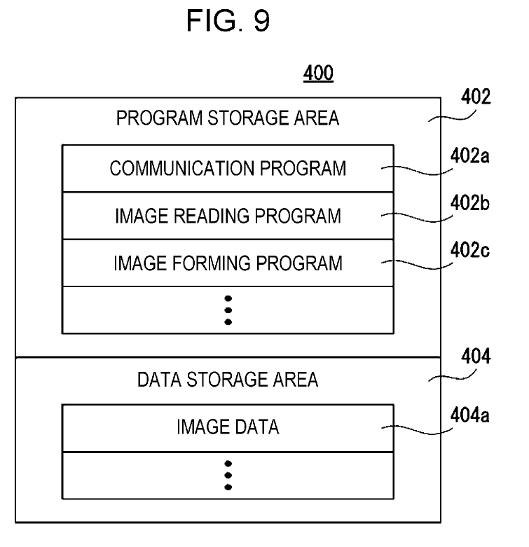

The image forming unit 74 is built in the device main body 80, and is provided below the image reading unit 72. The image forming unit 74 includes a photosensitive drum, a charging section, an exposure section, a developing section, a transfer section, a fixing section, and the like. The image forming unit 74 forms an image on the recording medium (paper), which is transported from the paper feeding unit 76 or the like, using an electronic photograph method, and discharges the paper, on which the image is completely formed, to the paper discharge tray 78 provided between the image reading unit 72 and the image forming unit 74. Meanwhile, image data which is read using the image reading unit 72, image data which is transmitted from the information processing device 10, image data which is transmitted from the external computer, or the like is used as the image data 404a (refer to FIG. 9) which is used to form the image on the paper. In addition, the recording medium is not limited to the paper, and a sheet other than the paper, such as an OHP film, may be used.

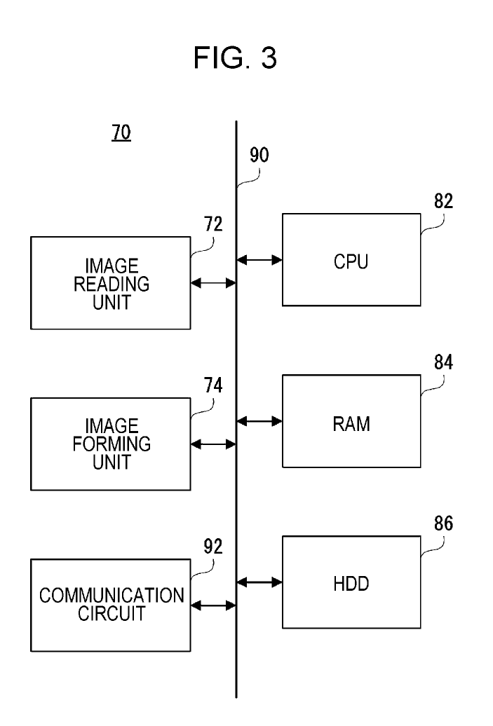

FIG. 3 is a block diagram illustrating an electrical configuration of the image forming device 70 illustrated in FIG. 1. Referring to FIG. 3, the image forming device 70 includes a CPU 82. A RAM 84, an HDD 86, the image reading unit 72, the image forming unit 74, and a communication circuit 92 are connected to the CPU 82 through a bus 90.

The CPU 82 performs overall control on the image forming device 70. The RAM 84 is used as a work area and a buffer area of the CPU 82.

The HDD 86 is a main storage unit of the image forming device 70, and appropriately stores a control program, which is used for the CPU 82 to control operations of respective parts of the image forming device 70, the display image data for the various screens, and the like. However, instead of the HDD 86 or together with the HDD 86, another non-volatile memory, such as an SSD, a flash memory, or an EEPROM, may be used.

The communication circuit 92 is a communication circuit used to connect the network such as the Internet. The communication circuit 92 is a wired communication circuit or a wireless communication circuit, and communicates with the external computer, such as the server, via the network according to an instruction from the CPU 82. Meanwhile, the communication circuit 92 is capable of directly communicating with the information processing device 10 in the wired or wireless manner without passing via the network.

Meanwhile, the electrical configuration of the image forming device 70 illustrated in FIG. 3 is only an example, and it is not demanded to be limited thereto.

In the information processing system 100, which has the above configuration, a plurality of electronic money brands are displayed on the display 14 of the information processing device 10 and the user is caused to select the electronic money for settlement. In this case, the user performs settlement using the electronic money for settlement after selecting the service or the like.

However, in an information processing system according to the related art, in a case where the balance of the electronic money for settlement is insufficient for the amount of money of the charge (hereinafter, there is a case of being referred to as the “charge for the service or the like”) relevant to provision of the service or the like, it is not possible to perform the settlement. In this case, it is demanded for the user to change a payment method to cash or another electronic money or to perform the settlement again after increasing the balance of the electronic money for settlement, thereby being troublesome. Therefore, there is room to improve convenience.

Here, in the first embodiment, a plurality of amount of payable money corresponding to each of a plurality of payment methods including the electronic money is detected, and the settlement is permitted in a case where the total amount (a sum of money) of the plurality of amounts of payable money reaches the amount of money of the charge for the service or the like.

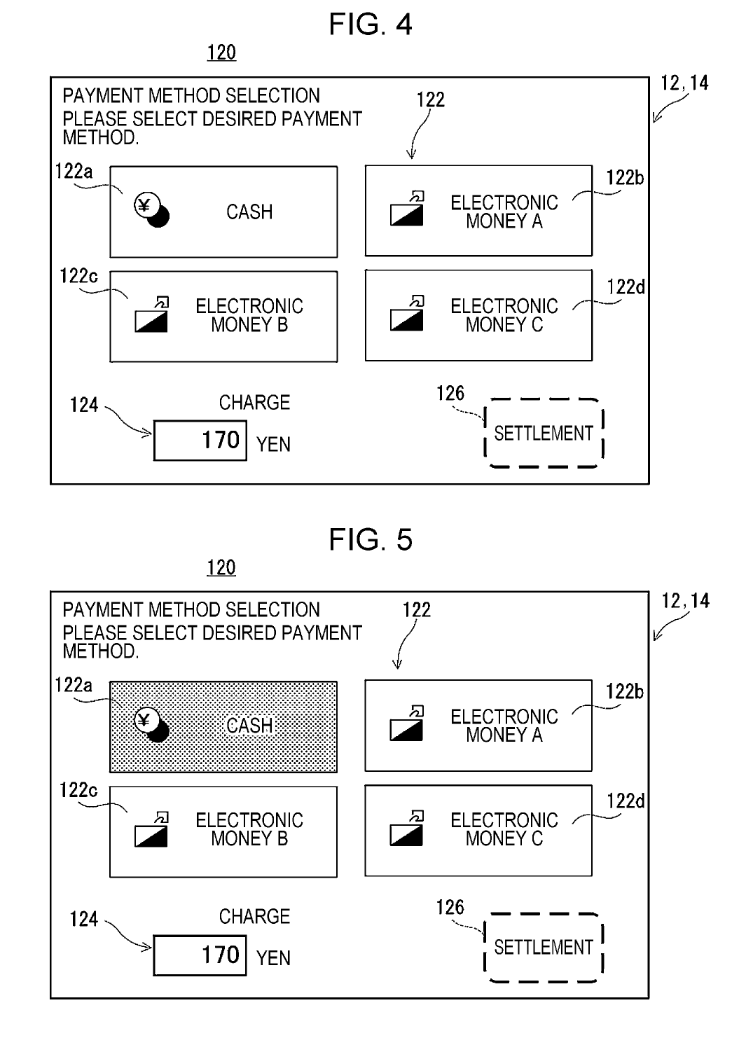

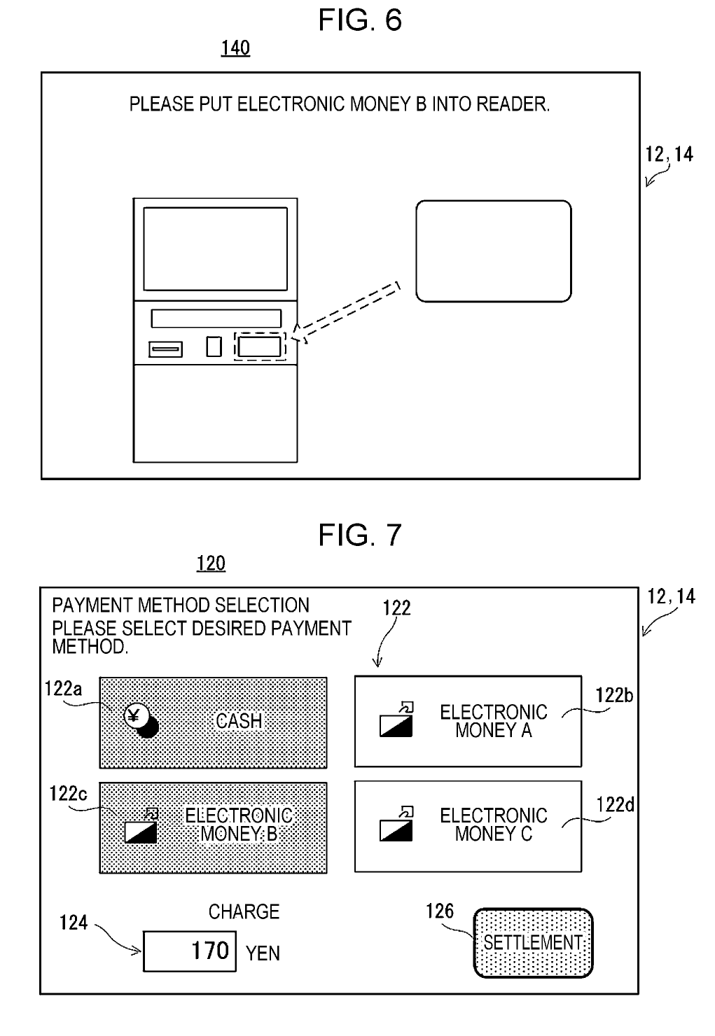

Hereinafter, an example of an operation of the information processing system 100 will be described with reference to FIGS. 4 to 7. FIG. 4 is a diagram illustrating an example of a payment method selection screen 120. FIG. 5 is a diagram illustrating an example of the payment method selection screen 120 in a state in which one payment method is selected. FIG. 6 is a diagram illustrating an example of an electronic money reception screen 140. FIG. 7 is a diagram illustrating an example of the payment, method selection screen 120 in a state in which a plurality of payment methods are selected.

In the information processing system 100 according to the first embodiment, various operation screens are displayed on the display 14 of the information processing device 10, and a user operation is received according to the touch input performed on the touch panel 12. The user selects a desired service or the like by touching an icon or the like which is displayed on the operation screen. Furthermore, in a case where content of the service or the like, which is desired for the user, is determined, the payment method selection screen 120 is displayed on the display 14, as illustrated in FIG. 4.

The payment method selection screen 120 is a screen used to select the payment method (settlement method) of the charge for the service or the like. The payment method selection screen 120 is also one of the operation screens in the information processing system 100.

The payment method selection screen 120 includes a plurality of selection icons 122, a charge display area 124, and a settlement icon 126.

Each of the plurality of selection icons 122 is an icon which corresponds to each of the plurality of payment methods which are usable in the information processing system 100 and are used to select payment methods for settlement. Specifically, in the payment method selection screen 120, selection icons 122a to 122d are provided. However, at least one of the selection icons 122a to 122d corresponds to a payment method using the electronic money.

In the first embodiment, the selection icon 122a corresponds to a payment method using the cash. In addition, the selection icon 122b corresponds to a payment method using electronic money A, the selection icon 122c corresponds to a payment method using electronic money B, and the selection icon 122d corresponds to a payment method using electronic money C. However, the electronic money A, the electronic money B, and the electronic money C respectively correspond to advance payment (prepaid)-type electronic money, and are electronic money of brands which are different from each other. In addition, balances corresponding to the amount of previously deposited money exist for the electronic money A, the electronic money B, and the electronic money C, respectively. Meanwhile, in a case where certain electronic money is not deposited, the balance of the electronic money is 0 (zero).

In the selection icon 122a, an appropriate string, a figure, or the like, which indicates a payment method using the cash, is written. In addition, in the selection icons 122b to 122d, appropriate strings, figures, or the like, which indicate the brands of the electronic money, are written such that it is possible to identify the brands of the relevant electronic money, respectively.

In the charge display area 124, the amount of money of the charge for the service or the like is displayed. In the example illustrated in FIG. 4, “170 yen” is displayed as the amount of money of the charge for the service or the like. Meanwhile, the amount of money of the charge for the service or the like is determined according to content of the service or the like which is desired for the user.

A function used to perform the settlement process is assigned to the settlement icon 126. In a case where the settlement icon 126 is touched (selected), settlement is performed using a payment method, which is selected by the user, for the settlement. However, the settlement icon 126 is valid in a case where the total amount of payable money in the plurality of payment methods (hereinafter, there is a case of being simply referred to as “the total amount of the payable money”) reaches the amount of money of the charge for the service or the like. In contrast, the settlement icon 126 is invalid in a case where the total amount of payable money does not reach the amount of money of the charge for the service or the like. Therefore, the settlement icon 126 is not selected even in a case of being touched. Therefore, in a case where the settlement icon 126 is invalid, it is not possible to perform the settlement.

FIG. 4 illustrates a state in which the payment method for settlement is not selected. Here, in the first embodiment, the amount of payable money corresponding to a payment method (a payment method other than the payment method for settlement), which is not selected as the payment methods for settlement, is treated as 0 (zero). Therefore, in a case where the payment method for settlement is not selected, the amount of payable money of all the payment methods is 0 (zero), and thus the total amount of payable money is 0 (zero). In such a case, the total amount of payable money does not reach the amount of money of the charge for the service or the like, and thus the settlement icon 126 is invalid. Therefore, it is not possible to perform the settlement.

In a case where any of the plurality of selection icons 122 is touched in the payment method selection screen 120 illustrated in FIG. 4, a payment method corresponding to the touched selection icon 122 is selected as the payment method for settlement. For example, in a case where the selection icon 122a corresponding to the cash is touched as illustrated in FIG. 5, the cash is selected as the payment method for settlement.

Here, in a state in which the plurality of selection icons 122 are not respectively selected (normal state), only hues of a white color and a black color are attached, and the hues other than the white color and the black color are not attached. In contrast, in a case where the payment method for settlement is selected, a display aspect of the selection icon 122 corresponding to the payment method for settlement changes. In the example illustrated in FIG. 5, a display aspect of the selection icon 122a changes. Meanwhile, in FIG. 5, a pattern is attached to the touched selection icon 122a. The pattern expresses that the hue (a color other than the white color and the black color), which is appropriate to the touched selection icon 122a, is attached.

Meanwhile, in a case where the selection icon 122 in the selected state is touched, selection of the touched selection icons 122 is released, and a payment method corresponding to the selection icon 122 does not become the payment method for settlement.

In a case where the cash is selected as the payment method for settlement, the user may insert the cash after the cash is selected as the payment method for settlement or may insert the cash before the cash is selected as the payment method for settlement. However, in a case where the cash is inserted after the payment method selection screen 120 is displayed on the display 14 and before the cash is selected as the payment method for settlement, a state (state illustrated in FIG. 5) in which the cash is automatically selected may be made in a case where the cash is inserted or a state in which the cash is selected may be made in a case where the selection icon 122a corresponding to the cash is touched. In addition, in a case where the cash is inserted before the payment method selection screen 120 is displayed (before content of the service or the like is determined), a state in which the cash is selected from the beginning as the payment method for settlement may be made in a case where the payment method selection screen 120 is displayed on the display 14.

As illustrated in FIG. 5, in a case where the cash is selected as the payment method for settlement and the cash is inserted, the amount of money to be inserted (the amount of payable money using the cash) is calculated. Here, since the payment method other than the cash is not selected, the amount of payable money using the payment method other than the cash is 0 (zero). Therefore, the amount of payable money using the cash becomes the total amount of payable money. However, FIG. 5 illustrates a case where the amount of payable money using the cash is smaller than the amount of money of the charge for the service or the like. Therefore, since the total amount of payable money does not reach the amount of money of the charge for the service or the like, the settlement icon 126 is invalid. Accordingly, it is not possible to perform the settlement.

However, in the payment method selection screen 120, it is possible to select the plurality of payment methods for settlement. That is, it is possible to further select a payment method other than the already selected payment method for settlement as the payment method for settlement. For example, as illustrated in FIG. 5, in the case where the cash is selected as the payment method for settlement, it is possible to select a payment method other than the cash (payment method using the electronic money) as the payment method for settlement.

Here, in a case where any of the selection icons 122 (the selection icons 122b to 122d in the first embodiment) used to select the electronic money A, the electronic money B, and the electronic money C is touched, the payment method using the electronic money corresponding to the touched selection icon 122 is selected as the payment method for settlement.

In a case where the electronic money is selected as the payment method for settlement, the electronic money reception screen 140 is displayed on the display 14, as illustrated in FIG. 6. The electronic money reception screen 140 is a screen used to urge the user to put the electronic money medium corresponding to the electronic money selected in the payment method selection screen 120 over the near field communication unit 22. For example, in a case where the selection icon 122c corresponding to the electronic money B is touched in the payment method selection screen 120, an appropriate string, a figure, or the like, which is used to urge the user to put the electronic money medium that stores data for the electronic money B (an IC card for the electronic money B or a mobile terminal for the electronic money B) over the near field communication unit 22, is displayed on the electronic money reception screen 140.

Furthermore, in a case where the electronic money medium is put over the near field communication unit 22, electronic money data which is stored in the electronic money medium is read by the near field communication unit 22. However, the electronic money data includes data for the brand of the relevant electronic money and the balance of the electronic money (the amount of payable money using the electronic money). Therefore, in a case where the electronic money medium corresponding to the electronic money B is put over the near field communication unit 22, the information processing device 10 reads data for the brand of the electronic money B and the balance of the electronic money B (the amount of payable money using the electronic money B).

In addition, in a case where the electronic money data for the electronic money B is normally read, the payment method selection screen 120 is displayed on the display 14, as illustrated in FIG. 7. in FIG. 7, since the electronic money B is selected as the payment method for settlement, a display aspect of the selection icon 122c corresponding to the electronic money B changes. Meanwhile, the display aspect of the selection icon 122c is the same as the display aspect of the selection icon 122a which is previously selected.

As described above, in a case where the plurality of payment methods for settlement are selected, the total amount of payable money is calculated again. In the example illustrated in FIG. 7, the total amount of payable money is the amount of money which is acquired by adding the amount of payable money using the cash to the amount of payable money using the electronic money B. However, FIG. 7 illustrates a case where the total amount of payable money, which is acquired by adding the amount of payable money using the cash to the amount of payable money using the electronic money B, is equal to or larger than the amount of money of the charge for the service or the like. Therefore, since the total amount of payable money reaches the amount of money of the charge for the service or the like, the settlement icon 126 is valid. That is, it is possible to select the settlement icon 126 and it is possible to perform settlement.

As illustrated in FIG. 7, in a case where the settlement icon 126 is selected in a state in which the total amount of payable money reaches the amount of money of the charge for the service or the like, the service or the like is provided in such a way that the charge for the service or the like is paid using the cash and the electronic money and the settlement is completed.

Meanwhile, it is possible to further select a payment method for settlement other than the already selected payment method for settlement in the payment method selection screen 120 even in a case where the settlement icon 126 is valid. In addition, it is possible to select the selection icon 122 used to select the payment method for settlement regardless of the amount of payable money using the relevant payment method. For example, even in a case where the amount of payable money, which corresponds to a relevant payment method, is 0 (zero), it is possible to select the selection icon 122 used to select the payment method.

In addition, as described above, in a case where the selection icon 122 corresponding to the already selected payment method for settlement is selected again, the payment method corresponding to the selection icon 122 does not become the payment method for settlement in the payment method selection screen 120. That is, the number of payment methods for settlement decreases. Here, the total amount of payable money is calculated again in accordance that the number of payment methods for settlement decreases (changes). For example, even in the case where the total amount of payable money reaches the amount of money of the charge for the service or the like before the number of payment methods for settlement decreases, the settlement icon 126 becomes invalid in a case where the total amount of payable money does not reach the amount of money of the charge for the service or the like because the number of payment methods for settlement decreases. In contrast, even in a case where the number of payment methods for settlement decreases, the settlement icon 126 is valid in a case where the total amount of payable money reaches the amount of money of the charge for the service or the like.

Meanwhile, in a case where the settlement is performed in a state in which the plurality of payment methods for settlement are selected, setting of the amount of payment money (division performed on the amount of payment money) in each of the payment methods for settlement may be automatically performed. For example, payment may be performed equally from each of the plurality of payment methods for settlement. In addition, one of the plurality of payment methods for settlement is the cash, the payment is preferentially performed using the cash, and the remaining amount of money may be paid using the electronic money. Furthermore, in a case where a trouble occurs in the information processing device 10 and it is previously known that the electronic money, which is difficult to be refunded, exists, the payment is preferentially performed using the electronic money which is difficult to be refunded, and the amount of remaining money may be paid using another payment method for settlement.

In addition, in a case where the settlement is performed in a state in which the plurality of payment methods for settlement are selected, setting of the amount of payment money in the respective payment methods for settlement may be manually performed by the user. In this case, a setting screen, which is used to set the amount of payment money in each of the payment methods for settlement or a ratio of the amount of payment money, is displayed on the display 14, and the amount of payment money in each of the payment methods for settlement is set according to the user operation.

The above-described operation of the information processing system 100 is realized in such a way that the CPU 32 of the information processing device 10 executes an information processing program, which is stored in the RAM 34, for the information processing device 10, and the CPU 82 of the image forming device 70 executes an information processing program, which is stored in the RAM 84, for the image forming device 70. A detailed process will be described later using a flowchart.

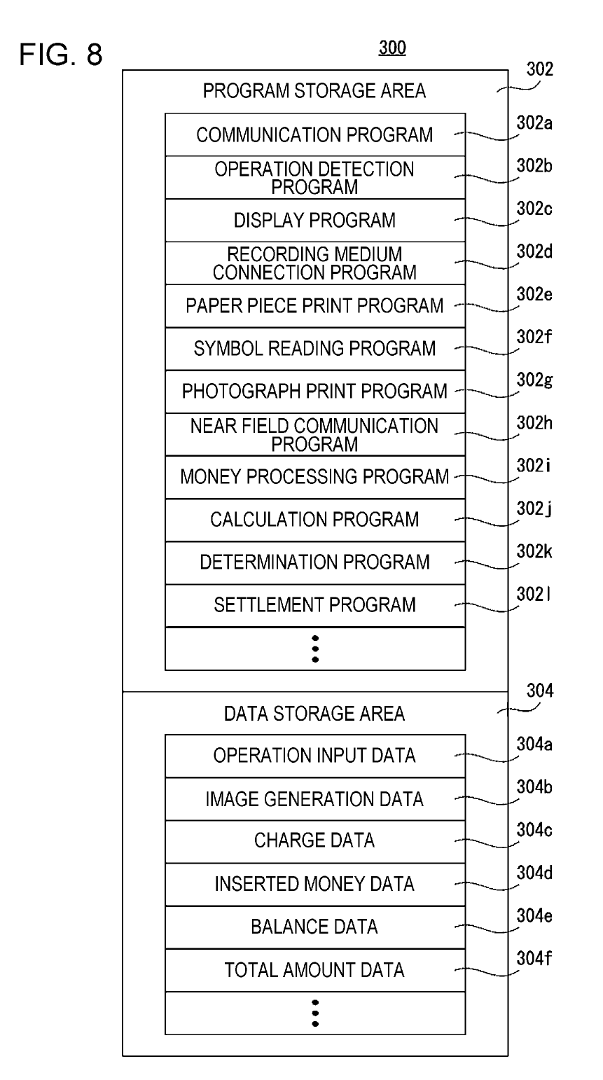

FIG. 8 is a diagram illustrating an example of the memory map 300 of the RAM 34 of the information processing device 10 illustrated in FIG. 2. As illustrated in FIG. 8, the RAM 34 includes a program storage area 302 and a data storage area 304. As described above, the information processing program of the information processing device 10 is stored in the program storage area 302 of the RAM 34. The information processing program of the information processing device 10 includes a communication program 302a, an operation detection program 302b, a display program 302c, a recording medium connection program 302d, a paper piece print program 302e, a symbol reading program 302f, a photograph print program 302g, a near field communication program 302h, a money processing program 302i, a calculation program 302j, a determination program 302k, and a settlement program 302l.

The communication program 302a is a program used to communicate (transmit and receive) data with the image forming device 70, another computer, such as the server, or another machine via the network.

The operation detection program 302b is a program used to detect the touch input, and the CPU 32 acquires the touch coordinate data output from the touch panel 12 according to the operation detection program 302b, and stores the acquired touch coordinate data in the RAM 34 in the time series.

The display program 302c is a program used to generate the display image data, that is, screen data, such as the above-described various operation screens, using the image generation data 304b which will be described later, and to output the generated display image data to the display 14.

The recording medium connection program 302d is a program used to control writing of data to the various recording media mounted on the recording medium connection unit 16 and reading from the various recording media.

The paper piece print program 302e is a program used to print a string, an image, a barcode, or the like on the roll paper by controlling the paper piece printer 18.

The symbol reading program 302f is a program used to extract a symbol image from a captured image, which is imaged by the laser scanner or the camera, and to decode the extracted symbol image by controlling the symbol reading unit 20.

The photograph print program 302g is a program used to print an image on the photograph paper by controlling the photo printer 26.

The near field communication program 302h is a program used to realize data communication with the communication target, such as the electronic money medium, by controlling the near field communication unit 22. That is, in a case where the near field communication program 302h is executed, the electronic money data is transmitted and received between the near field communication unit 22 and the electronic money medium.

The money processing program 302i is a program used to calculate the amount of money to be inserted according to the type and the number of coins accommodated in the coin storage section and the type and the number of pieces of paper money accommodated in the paper money storage section by controlling the money processing unit 24. In addition, the money processing program 302i is a program used to return the coins from the coin return opening 24b or to return the paper money from the paper money insertion opening according to the balance, which remains after subtracting the predetermined charge for the service or the like from the amount of money to be inserted, by controlling the money processing unit 24.

The calculation program 302j is a program used to calculate the total amount of payable money. Specifically, the calculation program 302j is a program used to calculate the total amount of the money that is payable using the payment method for settlement (the amount of payable money using the cash or/and the amount of payable money using the electronic money).

The determination program 302k is a program used to determine whether or not the total amount of payable money, which is calculated according to the calculation program 302j, reaches the amount of money of the charge relevant to provision of the service or the like.

The settlement program 302l is a program used to make a state in which it is possible to perform the settlement by causing the settlement icon 126 to be valid in a case where it is determined that the total amount of payable money reaches the amount of money of the charge relevant to provision of the service or the like. In addition, the settlement program 302l is a program used to perform the settlement in a case where the settlement icon 126 is valid and the settlement icon 126 is selected.

Meanwhile, although not illustrated in FIG. 8, the program storage area 302 stores a program used to set the charge relevant to provision of the service or the like in the information processing system 100, a program used to select and perform various functions included in the information processing device 10, and the like.

In addition, the data storage area 304 of the RAM 34 stores operation input data 304a, image generation data 304b, charge data 304c, inserted money data 304d, balance data 304e, total amount data 304f, and the like.

The operation input data 304a is data which is acquired by storing the touch coordinate data detected according to the operation detection program 302b in the time series.

The image generation data 304b is data, such as polygon data or texture data, which is used to generate the display image data corresponding to the various screens to be displayed on the display 14.

The charge data 304c is data which corresponds to the charge for the service or the like. The charge data 304c is generated according to the charge for the service or the like in a case where content of the service or the like, which is desired for the user, is determined. Meanwhile, predetermined charges are previously set for respective products and services which are provided in the information processing system 100.

The inserted money data 304d is data which corresponds to the amount of money to be inserted. The amount of money to be inserted is calculated according to the money processing program 302i. That is, the inserted money data 304d is data which corresponds to the amount of payable money using the cash.

The balance data 304e is data which corresponds to the balance of the electronic money according to the electronic money data that is acquired according to the near field communication program 302h. That is, the balance data 304e is data which corresponds to the amount of payable money using the electronic money. However, there is a case where the balance data 304e includes data which corresponds to the balance of the electronic money of each of the plurality of brands. In this case, the data corresponding to the balance of the electronic money is managed for each of the brands of the electronic money.

The total amount data 304f is data which corresponds to the total amount of payable money using the payment method for settlement (the amount of money to be inserted (the amount of payable money using the cash) corresponding to the inserted money data 304d or/and the amount of money of the balance (the amount of payable money using the electronic money), which corresponds to the balance data 304e), of the electronic money of one or more brands.

Meanwhile, although not illustrated in FIG. 8, the data storage area 304 stores another data which is desired to execute the information processing program of the information processing device 10, or is provided with a timer (counter) or a register which is desired to execute the information processing program of the information processing device 10.

FIG. 9 is a diagram illustrating an example of a memory map 400 of the RAM 84 of the image forming device 70 illustrated in FIG. 3. As illustrated in FIG. 9, the RAM 84 includes a program storage area 402 and a data storage area 404. As described above, the program storage area 402 of the RAM 84 stores the information processing program for the image forming device 70. The information processing program for the image forming device 70 includes a communication program 402a, an image reading program 402b, and an image forming program 402c.

The communication program 402a is a program used to perform communication with the information processing device 10, another computer, such as the server, or another machine via the network.

The image reading program 402b is a program used to read (scan) an image of a document placed on the document pedestal and to output an image signal (scan image data) corresponding to the read image by controlling the image reading unit 72.

The image forming program 402c is a program used to form a multicolor or monochrome image on the recording medium (paper) according to the image data 404a, such as the scan image data or the input image data, by controlling the image forming unit 74.

Meanwhile, although not illustrated in FIG. 9, the program storage area 402 stores a program or the like used to select and perform the various functions included in the image forming device 70.

In addition, the data storage area 404 of the RAM 84 stores the image data 404a or the like. The image data 404a includes image data which is read by the image reading unit 72, image data which is input from the external computer such as the server, and the like.

Meanwhile, although not illustrated in FIG. 9, the data storage area 404 stores another data which is desired to execute the information processing program for the image forming device 70, or is provided with a timer (counter) or a register which is desired to execute the information processing program for the image forming device 70.

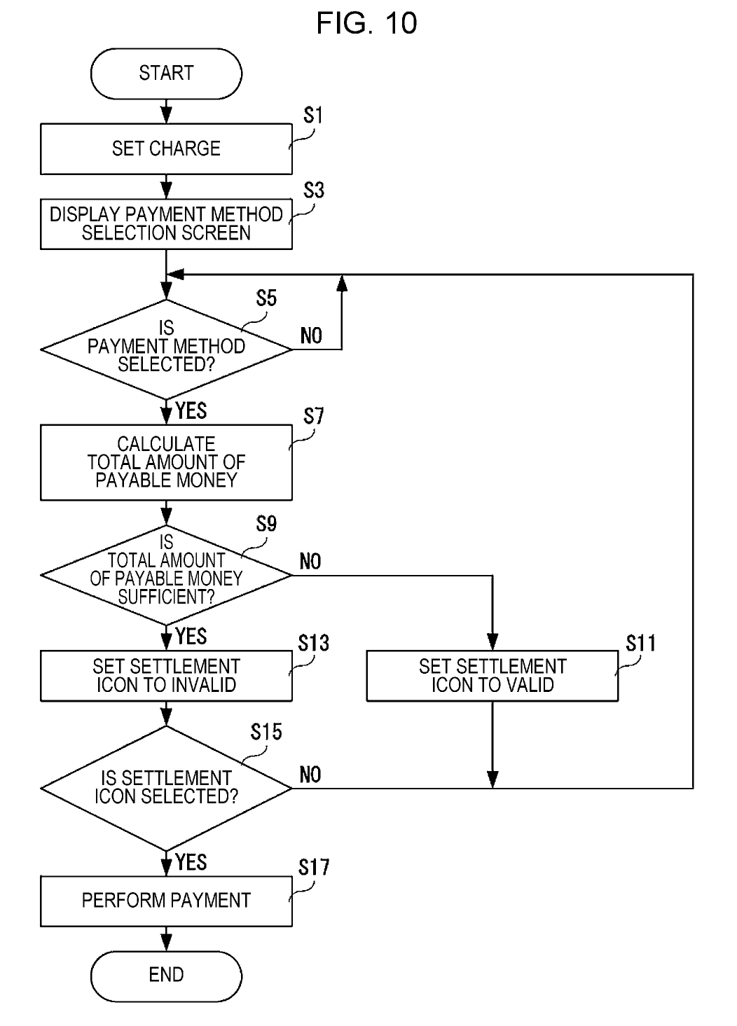

FIG. 10 is a flowchart illustrating an example of a settlement process which is performed in the CPU 32 of the information processing device 10 illustrated in FIG. 2. The settlement process starts in a case where the content of the service or the like, which is desired for the user, is determined.

As illustrated in FIG. 10, the CPU 32 of the information processing device 10 starts the settlement process. In step S1, the charge for the service or the like is set according to the content of the service or the like which is desired for the user. In step S3, the payment method selection screen 120 is displayed on the display 14, and the process proceeds to step S5.

In step S5, it is determined whether or not the payment method is selected in the payment method selection screen 120. Here, it is determined whether or not any of the plurality of selection icons 122 is selected with reference to the operation input data 304a.

In a case of “NO” in step S5, that is, in a case where the payment method is not selected, the process returns to step S5. In contrast, in a case of “YES” in step S5, that is, in a case where the payment method is selected, the total amount of payable money is calculated in step S7.

Furthermore, in step S9, it is determined whether or not the total amount of payable money reaches the amount of money of the charge for the service or the like. In a case of “NO” in step S9, that is, in a case where the total amount of payable money does not reach the amount of money of the charge for the service or the like, the settlement icon 126 is set to invalid in step S11, and the process returns to step S5. However, in a case where the settlement icon 126 is already set to invalid in step S11, the state is maintained without change. In contrast, in a case of “YES” in step S9, that is, in a case where the total amount of payable money reaches the amount of money of the charge for the service or the like, the settlement icon 126 is set to valid in step S13, and the process proceeds to step S15. However, in a case where the settlement icon 126 is already set to valid in step S13, the state is maintained without change.

In step S15, it is determined whether or not the settlement icon 126 is selected. In a case of “NO” in step S15, that is, in a case where the settlement icon 126 is not selected, the process returns to step S5. In contrast, in a case of “YES” in step S13, that is, in a case where the settlement icon 126 is selected, the settlement is performed in step S15, and the settlement process ends.

In the first embodiment, the amount of payable money corresponding to each of the plurality of payment methods is detected. In a case where the total amount of payable money reaches the amount of money of the charge relevant to provision of the service or the like, the settlement is permitted. Therefore, it is possible to provide a flexible settlement method, and thus it is possible to improve convenience of the user.

In addition, according to the first embodiment, in a case where any one of the selection icons 122 corresponding to the plurality of payment methods is touched in the payment method selection screen 120, it is possible to select a payment method for settlement. Therefore, tine operation is simple, and thus it is possible to improve the convenience of the user.

Furthermore, in the first embodiment, it is possible to select the payment method for settlement regardless of existence or non-existence of the amount of payable money. Therefore, it is possible to improve the convenience of the user.

Meanwhile, in the first embodiment, in a case where the total amount of payable money is calculated, the amount of payable money using a payment method other than the payment methods for settlement is treated while being set to 0 (zero). However, it is not desired to be limited thereto. For example, in the case where the total amount of payable money is calculated, only the amount of payable money using the payment method for settlement may be included. That is, the amount of payable money using the payment method other than the payment methods for settlement may not be treated from the beginning.

In addition, in a case where the total amount of payable money is calculated, the amount of payable money using the payment method other than the payment methods for settlement may be included. Here, there is a case where the settlement icon 126 is valid even though the payment method for settlement is not selected. Although not illustrated in FIG. 10, in a case where the settlement icon 126 is selected in a state in which the payment method for settlement is not selected, a screen, which causes the user to select the payment method for settlement from the payment methods in which the amount of payable money exists, is displayed on the display 14. In this manner, it is possible to perform the settlement regardless of the existence or non-existence of the selection of the payment method for settlement. Therefore, it is possible to provide a flexible settlement method, and thus it is possible to improve the convenience of the user.

Furthermore, in the first embodiment, in the case where the payment method for settlement is selected in the payment method selection screen 120, an appropriate hue is attached to the selection icon 122 which is selected by the user. However, it is not desired to be limited thereto. For example, each of the plurality of selection icons 122 may not flicker in a state of being not selected and may flicker in a state of being selected by the user. In this manner, it is possible for the user to recognise whether or not any one of the selection icons 122 is selected even though the hues are not attached to the selection icons 122.

### Second Embodiment

An information processing system 100 according to a second embodiment is the same as in the first embodiment other than a fact that the amount of payable money using the payment method for settlement is displayed. Therefore, content which is different from the first embodiment will be described, and duplicated description will not be repeated.

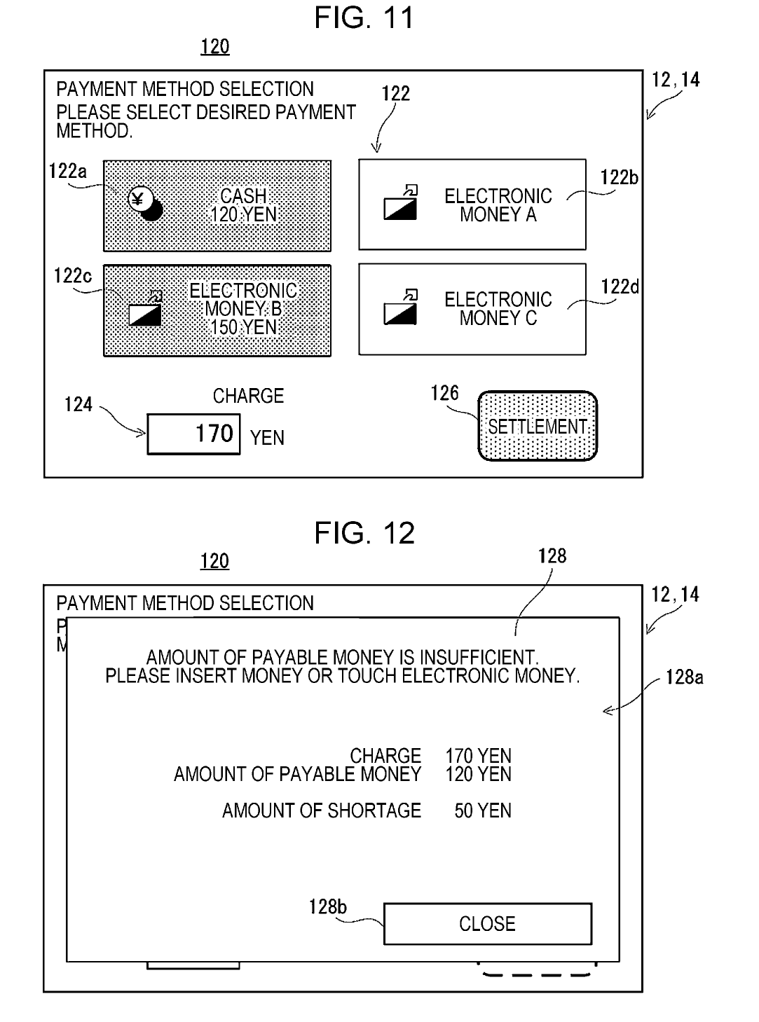

FIG. 11 is a diagram illustrating an example of a payment method selection screen 120 according to the second embodiment. As illustrated in FIG. 11, in the second embodiment, the amount of payable money using the payment method for settlement is displayed. Specifically, the amount of payable money is displayed in the selection icon 122 corresponding to the payment method for settlement.

However, in a case where the cash is selected as the payment method for settlement, the amount of money to be inserted is displayed as the amount of payable money using the cash. The amount of money to be inserted is displayed according to the inserted money data 304d. In addition, in a case where the electronic money is selected as the payment method for settlement, the balance of the electronic money is displayed as the amount of payable money using the electronic money. The balance of the electronic money is displayed according to the balance data 304e.

According to the second embodiment, the amount of payable money using the payment method for settlement is displayed. Therefore, it is possible for the user to recognize whether or not the total amount of payable money reaches the amount of money of the charge relevant to provision of the service or the like. Therefore, in a case where the total amount of payable money does not reach the amount of money of the charge relevant to provision of the service or the like, a degree of the amount of payable money to be added is understood, thereby being convenient.

In addition, according to the second embodiment, in a case where the electronic money is selected as the payment method for settlement, the balance of the electronic money is displayed. Therefore, it is possible for the user to confirm the balance of the electronic money which possessed by the user.

### Third Embodiment

An information processing system 100 according to a third embodiment is the same as in the first embodiment other than a fact that it is possible to touch the settlement icon 126 in a case where the total amount of payable money does not reach the amount of money of the charge relevant to provision of the service or the like. Therefore, content which is different from the first embodiment will be described, and duplicated description will not be repeated.

FIG. 12 is a diagram illustrating an example of the payment method selection screen 120 which includes a notification image 128 according to the third embodiment. In the third embodiment, it is possible to touch the settlement icon 126 even in the case where the total amount of payable money does not reach the amount of money of the charge relevant to provision of the service or the like. However, if the settlement icon 126 is touched in the case where the total amount of payable money does not reach the amount of money of the charge relevant to provision of the service or the like, the settlement is not performed and the notification image 128 is displayed on the display 14, as illustrated in FIG. 12.

In the notification image 128, an area 128a, which includes information relevant to the settlement, and a close icon 128b are displayed.

In the area 128a, a message used to notify that the total amount of payable money does not reach the amount of money of the charge relevant to provision of the service or the like, the total amount of payable money, the amount of money of the charge for the service or the like, and the amount of shortage for performing the settlement are displayed.

The close icon 128b is a software key used to close the notification image 128 and to return to normal payment method selection screen 120.

According to the third embodiment, it is possible to cause the user to recognize a notification that the total amount of payable money does not reach the amount of money of the charge for the service or the like.

In addition, according to the third embodiment, it is possible to cause the user to recognize the amount of shortage for performing the settlement.

Meanwhile, it is possible to apply an aspect illustrated in the third embodiment in combination with the second embodiment.

In addition, in the above-described embodiments, the case where the electronic money which may be selected as the payment method is the prepaid-type electronic money is described. However, it is not desired to be limited thereto. For example, later payment (postpaid)-type electronic money may be selected as the payment method. In the postpaid-type electronic money, the amount of payable money is set to the amount of money which is the same as the amount of money of the charge. Therefore, it is determined that the total amount of payable money reaches the amount of money of the charge relevant to provision of the service or the like in a point of time in which the postpaid-type electronic money is selected as the payment method.

Furthermore, in the above-described embodiments, the electronic money data, which is stored in the electronic money medium, includes the balance of the electronic money. However, it is not desired to be limited thereto. For example, instead of the balance of the electronic money, the electronic money data may include identification information used to specify the user (or the electronic money medium itself) who uses (possesses) the electronic money medium. In this case, the balance of the electronic money is stored in the storage unit of the external computer, such as the server, which is capable of communicating with the information processing device 10. However, the balance of the electronic money is stored in association with the identification information. Therefore, in a case where the information processing device 10 acquires the identification information stored in the electronic money medium, the information processing device 10 accesses the storage unit of the external computer, and acquires the balance of the electronic money which is associated with the identification information.

Furthermore, in addition, in the above-described embodiments, the case where the total amount of payable money reaches the amount of money of the charge for the service or the like is set to valid. However, in addition thereto, a notification image, which includes a message used to notify that settlement is permitted, a message used to notify that the total amount of payable money reaches the amount of money of the charge relevant to provision of the service or the like, and the like, may be displayed on the display 14. In this manner, it is possible to cause the user to recognize that the settlement is permitted.

In addition, the numerical values, the screens, the detailed configurations, and the like which are provided in the above-described embodiments are examples, and appropriate changes are possible according to actual products. In addition, it is possible to appropriately change a processing sequence of the respective steps of the flowchart, which is illustrated in the above-described embodiment, in a case where the same result may be acquired.

The present disclosure contains subject matter related to that disclosed in Japanese Priority Patent Application JP 2017-211497 filed in the Japan Patent Office on Nov. 1, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A multimedia terminal, which is capable of performing settlement of a charge using a plurality of payment methods, the multimedia terminal comprising:
a detection section that detects a plurality of amounts of payable money corresponding to the plurality of payment methods, respectively;
a calculation section that calculates a total amount of the plurality of amounts of payable money which is detected by the detection section;
a determination section that determines whether or not the total amount, which is calculated by the calculation section, reaches an amount of money of the charge; and
a settlement permission section that permits the settlement in a case where it is determined that the total amount reaches the amount of money of the charge by the determination section.

2. The multimedia terminal according to claim 1, further comprising:
a display; and
a display section that displays, on the display, the plurality of amounts of payable money which is detected by the detection section.

3. The multimedia terminal according to claim 1, further comprising:
an operation unit that receives a user operation; and
a selection section that selects a payment method for settlement from the plurality of payment methods according to the user operation received by the operation unit.

4. The multimedia terminal according to claim 3,
wherein it is possible to select the payment method for settlement regardless of the amount of payable money.

5. An information processing system, comprising:
the multimedia terminal according to claim 1; and
an image forming device that is capable of communicating with the multimedia terminal.

6. A computer readable medium storing a control program of a multimedia terminal, which is capable of performing settlement of a charge using a plurality of payment methods, the control program causing a processor of the multimedia terminal to function as:
a detection section that detects a plurality of amounts of payable money corresponding to each of the plurality of payment methods, respectively;
a calculation section that calculates a total amount of the plurality of amounts of payable money which is detected by the detection section;
a determination section that determines whether or not the total amount, which is calculated by the calculation section, reaches an amount of money of the charge; and
a settlement permission section that permits the settlement in a case where it is determined that the total amount reaches the amount of money of the charge by the determination section.

7. A control method causing a processor of a multimedia terminal, which is capable of performing settlement of a charge using a plurality of payment methods, to perform a process, the process comprising:
detecting a plurality of amounts of payable money corresponding to each of the plurality of payment methods, respectively;
calculating a total amount of the detected plurality of amounts of payable money;
determining whether or not the calculated total amount reaches an amount of money of the charge; and
permitting the settlement in a case where it is determined that the total amount reaches the amount of money of the charge.
